(19) United States
(12) Patent Application Publication
(10) Pub. No.: US 2026/0162593 A1
(43) Pub. Date: Jun. 11, 2026

(54) DISPLAY DEVICE WITH VARIABLE REFRESH RATE, AN ELECTRONIC DEVICE, AND METHOD OF DRIVING THE SAME

(71) Applicant: SAMSUNG DISPLAY CO., LTD., YONGIN-SI (KR)

(72) Inventors: IN-WON JIN, Yongin-si (KR); SANGWOO KIM, Yongin-si (KR); SEONJEONG YUN, Yongin-si (KR); YONGHOON CHUN, Yongin-si (KR)

(21) Appl. No.: 19/339,448

(22) Filed: Sep. 25, 2025

(30) Foreign Application Priority Data
Dec. 5, 2024 (KR) 10-2024-0179671

(51) Int. Cl. G09G 3/32; G09G 3/3275

(52) U.S. Cl. CPC G09G 3/32; G09G 3/3275; G09G 2310/0245; G09G 2310/027; G09G 2310/0275; G09G 2320/0247; G09G 2330/021

(57) ABSTRACT

A display device includes a display panel including a pixel. The display device includes a controller configured to receive input grayscale and refresh rate data and generate output grayscales based on an input grayscale and a refresh rate, and transmit the output grayscales to a data driver. When the refresh rate changes from a low frequency to a higher frequency, an output grayscale higher than the input grayscale is sent to the pixel through the data driver.

### CROSS-REFERENCE TO RELATED APPLICATION(S)

This application claims priority under 35 U.S.C. § 119 to Korean Patent Application No. 10-2024-0179671, filed on Dec. 5, 2024, in the Korean Intellectual Property Office (KIPO), the disclosure of which is incorporated by reference herein in its entirety.

### TECHNICAL FIELD

The present disclosure relates to a display device and, more specifically, to a display device driven by a variable refresh rate, a method of driving the display device, and an electronic device including the display device.

### DESCRIPTION OF THE RELATED ART

A display device may include a display panel, a data driver, and a controller. The display panel may include pixels for displaying an image. The data driver may provide data voltages to the pixels. The controller may provide image data and a data control signal to the data driver.

The display device may be driven in a variable refresh rate (VRR) mode. In the variable refresh rate (VRR) mode, a refresh rate of the display panel may change. When the display device displays a moving image, the refresh rate of the display panel may increase to improve image quality of the display device. When the display device displays a still image, the refresh rate of the display panel may decrease to reduce power consumption of the display device.

### SUMMARY

Several embodiments of the disclosure provide a display device in which a luminance drop is reduced when the display device's refresh rate changes.

Several embodiments of the disclosure provide a method of driving a display device for reducing a luminance drop when the display device's refresh rate changes.

In several embodiments of the present disclosure, a display device includes a display panel including a pixel. The display device includes a controller configured to receive input grayscale and refresh rate data and generate output grayscales based on an input grayscale and a refresh rate, and transmit the output grayscales to a data driver. When the refresh rate changes from a low frequency to a higher frequency, an output grayscale higher than the input grayscale is sent to the pixel through the data driver.

In several embodiments, when the refresh rate changes from the low frequency to the higher frequency and a frequency difference between the higher frequency and the low frequency is greater than or equal to a reference frequency difference value, the output grayscale higher than the input grayscale may be sent to the pixel through the data driver.

In several embodiments, when the refresh rate changes from the low frequency to the higher frequency and the input grayscale is less than or equal to a reference grayscale, the output grayscale higher than the input grayscale may be sent to the pixel through the data driver.

In several embodiments, when the refresh rate changes from the low frequency to the higher frequency, a frequency difference between the higher frequency and the low frequency is greater than or equal to a reference frequency difference value, and the input grayscale is less than or equal to a reference grayscale, the output grayscale higher than the input grayscale may be sent to the pixel through the data driver.

In several embodiments, high-frequency frames may include a first high-frequency frame and a second high-frequency frame, an output grayscale of the first high-frequency frame that is higher than the input grayscale may be sent to the pixel, and an output grayscale of the second high-frequency frame that is equal to the input grayscale may be sent to the pixel.

In several embodiments, high-frequency frames may include a first high-frequency frame and a second high-frequency frame, and an output grayscale of the second high-frequency frame that is higher than the input grayscale may be sent to the pixel.

In several embodiments, the output grayscale of the second high-frequency frame may be less than the output grayscale of the first high-frequency frame.

In several embodiments, a compensation grayscale of the first high-frequency frame corresponding to a difference between the output grayscale of the first high-frequency frame and the input grayscale, may increase as a frequency difference between the higher frequency and the low frequency increases.

In several embodiments, the controller may include a frequency change determiner configured to determine a change in the refresh rate based on a vertical synchronization signal or a frequency change signal, a frequency difference comparator configured to compare a frequency difference between the higher frequency and the low frequency with a reference frequency difference value, and an input grayscale comparator configured to compare the input grayscale with a reference grayscale.

In several embodiments of the present disclosure, a method of driving a display device includes receiving input grayscale and refresh rate data, generating output grayscales based on an input grayscale and a refresh rate, and transmitting the output grayscales to a data driver. When the refresh rate of the display device changes from a low frequency to a higher frequency, an output grayscale higher than the input grayscale is sent to a pixel through the data driver.

In several embodiments, the method may include determining a change in the refresh rate based on a vertical synchronization signal or a frequency change signal.

In several embodiments, the method may include comparing a frequency difference between the higher frequency and the low frequency with a reference frequency difference value, and comparing the input grayscale with a reference grayscale.

In several embodiments, when the refresh rate changes from the low frequency to the higher frequency, the frequency difference is greater than or equal to the reference frequency difference value, and the input grayscale is less than or equal to the reference grayscale, the output grayscale higher than the input grayscale may be sent to the pixel through the data driver.

In several embodiments, high-frequency frames may include a first high-frequency frame and a second high-frequency frame, and an output grayscale of the second high-frequency frame that is equal to the input grayscale may be sent to the pixel.

In several embodiments, high-frequency frames may include a first high-frequency frame and a second high-frequency frame, and an output grayscale of the second high-frequency frame that is higher than the input grayscale may be sent to the pixel.

In several embodiments, the output grayscale of the second high-frequency frame that is less than an output grayscale of the first high-frequency frame may be sent to the pixel.

In several embodiments, a compensation grayscale of the first high-frequency frame corresponding to a difference between the output grayscale of the first high-frequency frame and the input grayscale, may increase as a frequency difference between the higher frequency and the low frequency increases.

In several embodiments of the present disclosure, an electronic device includes a display device configured to display an image, a processor configured to provide an input grayscale to the display device, and a power module configured to supply power to the display device and the processor. The display device includes a display panel including a pixel, and a controller configured to receive input grayscale and refresh rate data and generate output grayscales based on an input grayscale and a refresh rate, and transmit the output grayscales to a data driver. When the refresh rate of the display panel changes from a low frequency to a higher frequency, an output grayscale higher than the input grayscale is sent to the pixel through the data driver.

In several embodiments, when the refresh rate changes from the low frequency to the higher frequency and a frequency difference between the higher frequency and the low frequency is greater than or equal to a reference frequency difference value, the output grayscale higher than the input grayscale may be sent to the pixel through the data driver.

In several embodiments, when the refresh rate changes from the low frequency to the higher frequency and the input grayscale is less than or equal to a reference grayscale, the output grayscale higher than the input grayscale may be sent to the pixel through the data driver.

In the display device, the method of driving the display device, and the electronic device according to several embodiments, when the refresh rate of the display panel changes from the low frequency to the high frequency, the output grayscale of the first high-frequency frame is increased to greater than the input grayscale, and the viewer's perception of a decreased luminance is reduced.

### BRIEF DESCRIPTION OF THE DRAWINGS

The above and other features of the present disclosure will become apparent from the following description of the embodiments, taken in conjunction with the accompanying drawings, in which:

FIG. 1 is a block diagram illustrating a display device, according to several embodiments of the present disclosure.

FIG. 2 is a diagram for describing variable refresh rate (VRR) for driving a display device, according to several embodiments of the present disclosure.

FIG. 3 is a circuit diagram illustrating an example of a pixel of FIG. 1, according to several embodiments of the present disclosure.

FIG. 4 is a graph illustrating a luminance of a display panel of FIG. 1 when the display panel's refresh rate changes from a low frequency to a high frequency, and when a grayscale compensation for a first high-frequency frame is not performed, according to several embodiments of the present disclosure.

FIG. 5 is a table illustrating output grayscales of frames when the refresh rate changes from the low frequency to the high frequency, according to several embodiments of the present disclosure.

FIG. 6 is a table illustrating output grayscales of frames when the refresh rate changes from the low frequency to the high frequency, according to several embodiments of the present disclosure.

FIG. 7 is a graph illustrating a luminance of the display panel of FIG. 1 when the refresh rate changes from the low frequency to the high frequency, and when the grayscale compensation for the first high-frequency frame is performed, according to several embodiments of the present disclosure.

FIG. 8 is a table illustrating output grayscales of frames when the refresh rate changes from the low frequency to the high frequency, according to several embodiments of the present disclosure.

FIG. 9 is a block diagram illustrating an example of a controller of FIG. 1, according to several embodiments of the present disclosure.

FIG. 10 is a flowchart illustrating a method of driving a display device, according to several embodiments of the present disclosure.

FIG. 11 is a block diagram illustrating an electronic device, according to several embodiments of the present disclosure.

FIG. 12 is a diagram illustrating examples of electronic devices, according to several embodiments of the present disclosure.

### DETAILED DESCRIPTION OF THE EMBODIMENTS

Hereinafter, a display device with a variable refresh rate, a method of driving a display device, and an electronic device according to embodiments of the present disclosure will be described in more detail with reference to the accompanying drawings. This invention may, however, be embodied in different forms and should not necessarily be construed as limited to the embodiments set forth herein. Rather, these embodiments are provided so that this disclosure will be thorough and complete, and will fully convey the scope of the invention to those skilled in the art.

In the present disclosure, same reference numerals are used for the same components in the drawings, and redundant descriptions of the same components might be omitted. To the extent that an element is not described in detail with respect to a figure, it may be understood that the element is at least similar to a corresponding element that has been described elsewhere within the present disclosure.

Although the terms “first”, “second”, etc. may be used herein to describe various elements, these elements, should not necessarily be limited by these terms. These terms may be used to distinguish one element from another element. Thus, a first element discussed below may be termed a second element without departing from the teachings of one or more embodiments. The description of an element as a “first” element might not require or imply the presence of a second element or other elements. The terms “first”, “second”, etc., may also be used herein to differentiate different categories or sets of elements. For conciseness, the terms “first”, “second”, etc., may represent “first-category (or first-set)”, “second-category (or second-set)”, etc., respectively.

A display device may include a display panel, a data driver, and a controller. The display panel may include pixels for displaying an image. The display device may be driven in a variable refresh rate (VRR) mode. However, in the variable refresh rate (VRR) mode, when the refresh rate changes from a low frequency to a high frequency, viewers may perceive a decrease in luminance.

In several embodiments of the present disclosure, when the display device's refresh rate changes from a low frequency to a high frequency, an output grayscale higher than the input grayscale may be sent to a Pixel through a data driver. For example, an output grayscale of the first high-frequency frame may be compensated and increased to be higher than the input grayscale. Thus, the viewer's perception of a decreased luminance may be reduced or substantially prevented.

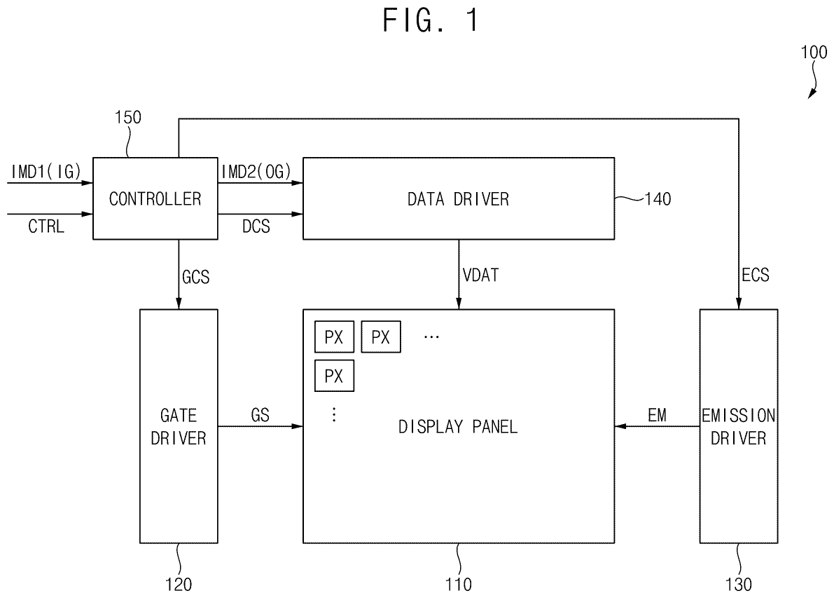

FIG. 1 is a block diagram illustrating a display device 100, according to several embodiments of the present disclosure.

Referring to FIG. 1, the display device 100 may include a display panel 110, a gate driver 120, an emission driver 130, a data driver 140, and a controller 150.

The display panel 110 may include a plurality of pixels PX.

The gate driver 120 may provide a gate signal GS to each of the pixels PX. The gate driver 120 may generate the gate signal GS based on a gate control signal GCS. The gate control signal GCS may include a gate clock signal, a gate start signal, etc.

The emission driver 130 may provide an emission signal EM to each of the pixels PX. The emission driver 130 may generate the emission signal EM based on an emission control signal ECS. The emission control signal ECS may include an emission clock signal, an emission start signal, etc.

The data driver 140 may provide a data voltage VDAT to each of the pixels PX. The data driver 140 may generate the data voltage VDAT based on an output grayscale OG of output image data IMD2 and a data control signal DCS. The data driver 140 may convert the output grayscale OG of a digital format into the data voltage VDAT of an analog format. The data control signal DCS may include a data clock signal, a load signal, an output data enable signal, etc.

The controller 150 may control the gate driver 120, the emission driver 130, and the data driver 140. The controller 150 may provide the gate control signal GCS to the gate driver 120. The controller 150 may provide the emission control signal ECS to the emission driver 130, and may provide the output image data IMD2 and the data control signal DCS to the data driver 140. The controller 150 may generate the output image data IMD2, the gate control signal GCS, the emission control signal ECS, and the data control signal DCS based on input image data IMD1 and a control signal CTRL. The controller 150 may generate the output grayscale OG of the output image data IMD2 based on an input grayscale IG of the input image data IMD1. In several embodiments, the controller 150 may transmit the output grayscales OG to the data driver 140. In several embodiments, the control signal CTRL may include a master clock signal, a vertical synchronization signal, a horizontal synchronization signal, an input data enable signal, etc.

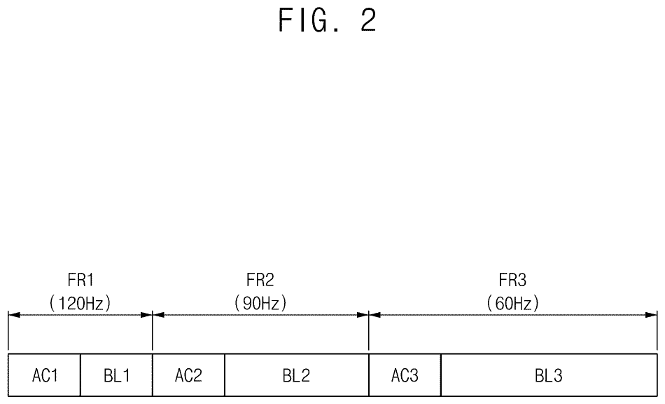

FIG. 2 is a diagram for describing variable refresh rate (VRR) for driving a display device, according to several embodiments of the present disclosure.

Referring to FIGS. 1 and 2, the display device 100 may be driven in a variable refresh rate mode in which a driving frequency may change. A length of a frame may decrease as the driving frequency of the frame increases, and the length of the frame may increase as the driving frequency of the frame decreases.

A first frame FR1 having a first driving frequency may include a first active period AC1 and a first blank period BL1. A second frame FR2 having a second driving frequency may include a second active period AC2 and a second blank period BL2. The second driving frequency may be different from the first driving frequency. A third frame FR3 having a third driving frequency may include a third active period AC3 and a third blank period BL3. The third driving frequency may be different from the first driving frequency and the second driving frequency. For example, as illustrated in FIG. 2, the first driving frequency may be 120 Hz, the second driving frequency may be 90 Hz, and the third driving frequency may be 60 Hz.

When the driving frequency changes, a length of a blank period of a frame may be adjusted to change a length of the frame. As illustrated in FIG. 2, when the first driving frequency, the second driving frequency, and the third driving frequency are different from each other, a length of the first active period AC1, a length of the second active period AC2, and a length of the third active period AC3 may be equal to each other, and a length of the first blank period BL1, a length of the second blank period BL2, and a length of the third blank period BL3 may be different from each other.

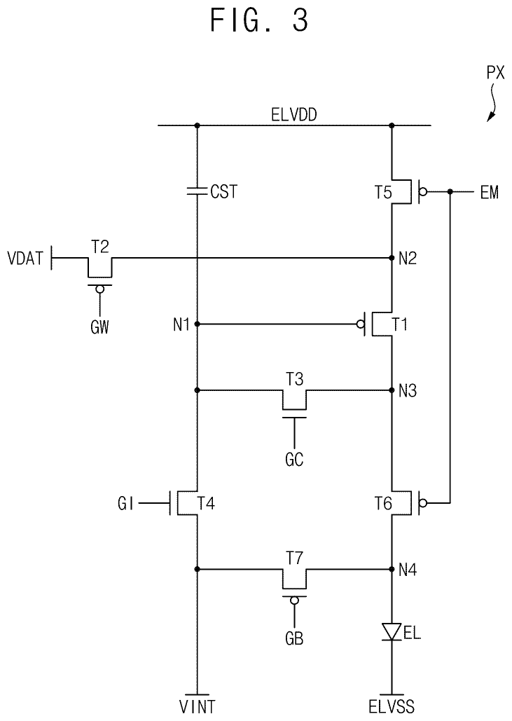

FIG. 3 is a circuit diagram illustrating an example of the pixel PX of FIG. 1.

Referring to FIGS. 1 and 3, the pixel PX may receive the gate signal GS, the emission signal EM, the data voltage VDAT, a first power voltage ELVDD, a second power voltage ELVSS, and an initialization voltage VINT, and may emit light with a luminance corresponding to the data voltage VDAT. The gate signal GS may include a write gate signal GW, a compensation gate signal GC, an initialization gate signal GI, and a bypass gate signal GB. A voltage level of the first power voltage ELVDD may be higher than a voltage level of the second power voltage ELVSS.

The pixel PX may include a first transistor T1, a second transistor T2, a third transistor T3, a fourth transistor T4, a fifth transistor T5, a sixth transistor T6, a seventh transistor T7, a capacitor CST, and a light-emitting element EL.

The first transistor T1 may generate a driving current flowing to the light-emitting element EL. The first transistor T1 may include a gate connected (for e.g., electrically) to a first node N1, a first electrode connected to a second node N2, and a second electrode connected to a third node N3. The first electrode of the first transistor T1 may be one of a source and a drain, and the second electrode of the first transistor T1 may be the other of the source and the drain. The first transistor T1 may be referred to as a driving transistor.

The second transistor T2 may transmit the data voltage VDAT to the second node N2 in response to the write gate signal GW. The second transistor T2 may include a gate that receives the write gate signal GW, a first electrode that receives the data voltage VDAT, and a second electrode connected to the second node N2. The first electrode of the second transistor T2 may be one of a source and a drain, and the second electrode of the second transistor T2 may be the other of the source and the drain.

The third transistor T3 may connect the third node N3 to the first node N1 in response to the compensation gate signal GC. The third transistor T3 may include a gate that receives the compensation gate signal GC, a first electrode connected to the third node N3, and a second electrode connected to the first node N1. The first electrode of the third transistor T3 may be one of a source and a drain, and the second electrode of the third transistor T3 may be the other of the source and the drain.

The fourth transistor T4 may transmit the initialization voltage VINT to the first node N1 in response to the initialization gate signal GI. The fourth transistor T4 may include a gate that receives the initialization gate signal GI, a first electrode that receives the initialization voltage VINT, and a second electrode connected to the first node N1. The first electrode of the fourth transistor T4 may be one of a source and a drain, and the second electrode of the fourth transistor T4 may be the other of the source and the drain.

The fifth transistor T5 may transmit the first power voltage ELVDD to the second node N2 in response to the emission signal EM. The fifth transistor T5 may include a gate that receives the emission signal EM, a first electrode that receives the first power voltage ELVDD, and a second electrode connected to the second node N2. The first electrode of the fifth transistor T5 may be one of a source and a drain, and the second electrode of the fifth transistor T5 may be the other of the source and the drain.

The sixth transistor T6 may connect the third node N3 to a fourth node N4 in response to the emission signal EM. The sixth transistor T6 may include a gate that receives the emission signal EM, a first electrode connected to the third node N3, and a second electrode connected to the fourth node N4. The first electrode of the sixth transistor T6 may be one of a source and a drain, and the second electrode of the sixth transistor T6 may be the other of the source and the drain.

The seventh transistor T7 may transmit the initialization voltage VINT to the fourth node N4 in response to the bypass gate signal GB. The seventh transistor T7 may include a gate that receives the bypass gate signal GB, a first electrode that receives the initialization voltage VINT, and a second electrode connected to the fourth node N4. The first electrode of the seventh transistor T7 may be one of a source and a drain, and the second electrode of the seventh transistor T7 may be the other of the source and the drain.

In several embodiments, each of the first transistor T1, the second transistor T2, the fifth transistor T5, the sixth transistor T6, and the seventh transistor T7 may be a P-type transistor (e.g., a p-channel metal oxide semiconductor (PMOS) transistor), and each of the third transistor T3 and the fourth transistor T4 may be an N-type transistor (e.g., an n-channel metal oxide semiconductor (NMOS) transistor). In several embodiments, at least one of the first transistor T1, the second transistor T2, the fifth transistor T5, the sixth transistor T6, and the seventh transistor T7 may be an N-type transistor, and at least one of the third transistor T3 and the fourth transistor T4 may be a P-type transistor.

The capacitor CST may store a voltage of the first node N1. The capacitor CST may include a first electrode connected to the first node N1 and a second electrode that receives the first power voltage ELVDD.

Although FIG. 3 illustrates an exemplary embodiment in which the pixel PX includes seven transistors and one capacitor, the present disclosure is not necessarily limited thereto. In several embodiments, the pixel PX may include two to six transistors. In several embodiments, the pixel PX may include eight or more transistors and/or two or more capacitors.

The light-emitting element EL may emit light with a luminance corresponding to the driving current. The light-emitting element EL may include a first electrode (e.g., an anode) connected to the fourth node N4 and a second electrode (e.g., a cathode) that receives the second power voltage ELVSS.

In several embodiments, the light-emitting element EL may be one of an organic light-emitting diode, an inorganic light-emitting diode, a micro light-emitting diode, and a quantum dot light-emitting diode.

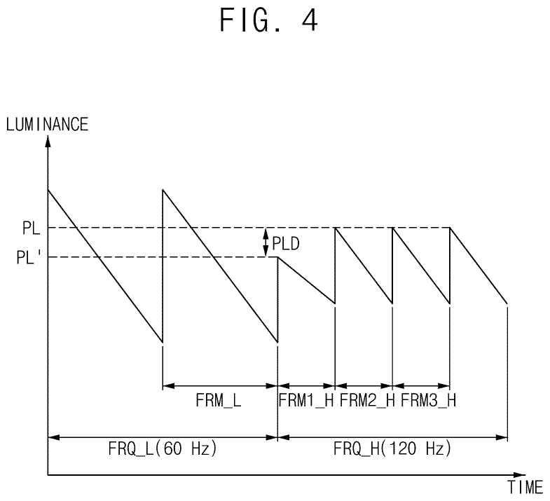

FIG. 4 is a graph illustrating a change in luminance over time of the display panel 110 of FIG. 1 when the display device's refresh rate changes from a low frequency FRQ_L to a high frequency FRQ_H, and when grayscale compensation for a first high-frequency frame FRM1_H is not performed.

Referring to FIG. 4, a length of a low-frequency frame FRM_L having a low frequency FRQ_L may be greater than a length of high-frequency frames FRM1_H, FRM2_H, and FRM3_H having a high frequency FRQ_H higher than the low frequency FRQ_L. For example, the low frequency FRQ_L may be 60 Hz, and the high frequency FRQ_H may be 120 Hz. When the input grayscale IG of the low-frequency frame FRM_L is equal to the input grayscale IG of the high-frequency frames FRM1_H, FRM2_H, and FRM3_H, a target luminance of the low-frequency frame FRM_L may be equal to a target luminance of the high-frequency frames FRM1_H, FRM2_H, and FRM3_H.

The low frequency and the high frequency may be relative terms. When a frequency of an n^{th} frame is lower than a frequency of an n+1^{th} frame, the n^{th} frame may be a low-frequency frame having the low frequency, and the n+1^{th} frame may be a high-frequency frame having the high frequency. When the frequency of the n^{th} frame is higher than the frequency of the n+1^{th} frame, the n^{th} frame may be the high-frequency frame having the high frequency, and the n+1^{th} frame may be the low-frequency frame having the low frequency.

When the driving frequency changes, hysteresis characteristic of the driving transistor T1 may change. The hysteresis characteristic of the driving transistor T1 may mean the driving current according to a gate-source voltage of the driving transistor T1. When the hysteresis characteristic of the driving transistor T1 changes, even if the input grayscales IG of frames are the same, luminances (for example, average luminances) of the frames corresponding to the input grayscales IG may be different. A luminance difference between the frames may be perceived as flicker by a user.

When the driving frequency changes from the low frequency FRQ_L to the high frequency FRQ_H, the hysteresis characteristic of the driving transistor T1 in a first high-frequency frame FRM1_H may change, and accordingly, a peak luminance PL′ of the first high-frequency frame FRM1_H may be lower than a peak luminance PL of the other high-frequency frames FRM2_H and FRM3_H. Due to a peak luminance difference PLD between the peak luminance PL of the other high-frequency frames FRM2_H and FRM3_H and the peak luminance PL′ of the first high-frequency frame FRM1_H, an average luminance of the first high-frequency frame FRM1_H may be lower than an average luminance of the other high-frequency frames FRM2_H and FRM3_H, and a luminance drop of the first high-frequency frame FRM1_H may be perceived as flicker by the viewer.

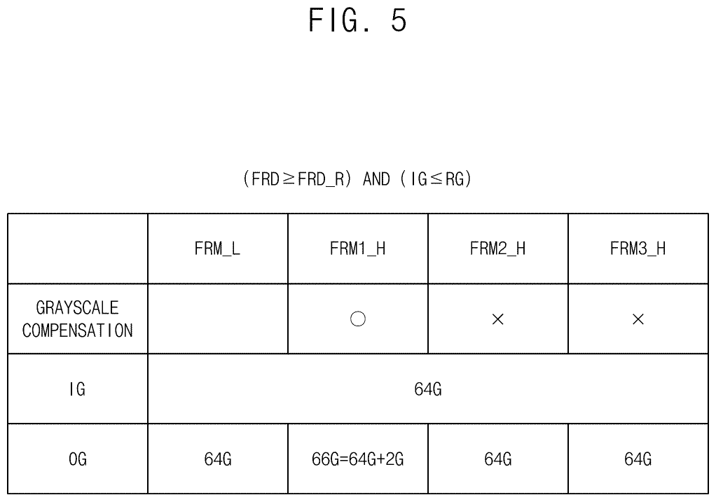

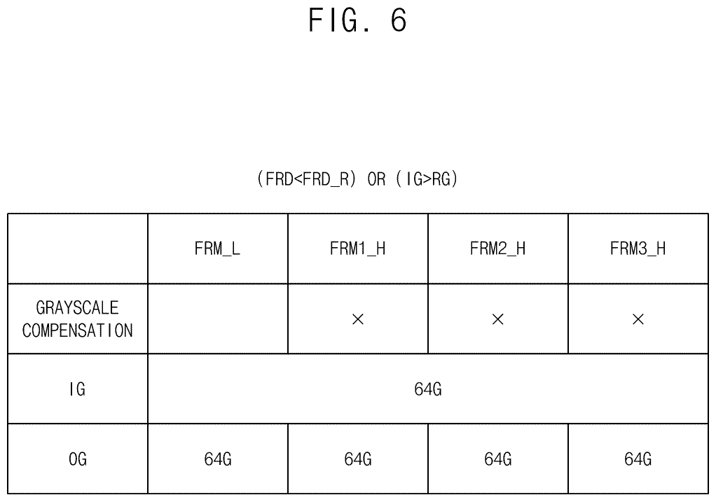

FIG. 5 is a table illustrating the output grayscales OG of a low-frequency frame FRM_L and high frequency frames, when the display device's refresh rate changes from the low frequency FRQ_L to the high frequency FRQ_H according to several embodiments. In several embodiments, the high frequency frames include a first high-frequency frame FRM1_H, a second high-frequency frame FRM2_H, and a third high frequency frame FRM3_H. FIG. 6 is a table illustrating the output grayscales OG of the frames FRM_L, FRM1_H, FRM2_H, and FRM3_H when the refresh rate changes from the low frequency FRQ_L to the high frequency FRQ_H according to several embodiments.

Referring to FIGS. 5 and 6, when the display device's refresh rate changes from the low frequency FRQ_L to the high frequency FRQ_H, an output grayscale OG higher than the input grayscale may be sent to the Pixel PX through the data driver 140. For example, in several embodiments, the output grayscale OG of the first high-frequency frame FRM1_H may be increased to be higher than the input grayscale IG. Increasing the output grayscale OG to be higher than the input grayscale may substantially prevent a luminance drop that occurs when the refresh rate changes from the low frequency FRQ_L to the high frequency FRQ_H.

In several embodiments, when the refresh rate changes from the low frequency FRQ_L to the high frequency FRQ_H and a frequency difference FRD between the high frequency FRQ_H and the low frequency FRQ_L is greater than or equal to a reference frequency difference value FRD_R, the output grayscale OG higher than the input grayscale IG may be sent to the pixel PX through the data driver 140. For example, the output grayscale OG of the first high-frequency frame FRM1_H may be increased to be higher than the input grayscale IG.

In several embodiments, even if the refresh rate changes from the low frequency FRQ_L to the high frequency FRQ_H, when the frequency difference FRD between the high frequency FRQ_H and the low frequency FRQ_L is less than the reference frequency difference value FRD_R, the output grayscale OG of the first high-frequency frame FRM1_H may be equal to the input grayscale IG. The reference frequency difference value FRD_R may mean a threshold frequency difference at which the luminance drop that occurs when the refresh rate changes from the low frequency FRQ_L to the high frequency FRQ_H may be perceived by the user. When the frequency difference FRD is greater than or equal to the reference frequency difference value FRD_R, the luminance drop may be perceived by the user because the increase in the refresh rate may be relatively large. When the frequency difference FRD is less than the reference frequency difference value FRD_R, the luminance drop might not be perceived by the user because the increase in the refresh rate is relatively small.

In several embodiments, when the refresh rate changes from the low frequency FRQ_L to the high frequency FRQ_H and the input grayscale IG is less than or equal to a reference grayscale RG, the output grayscale OG higher than the input grayscale IG may be sent to the pixel PX through the data driver 140. For example, when the refresh rate changes from the low frequency FRQ_L to the high frequency FRQ_H and the input grayscale IG is less than or equal to a reference grayscale RG, the output grayscale OG of the first high-frequency frame FRM1_H may be increased to be higher than the input grayscale IG. For example, even if the refresh rate changes from the low frequency FRQ_L to the high frequency FRQ_H, when the input grayscale IG is higher than the reference grayscale RG, the output grayscale OG of the first high-frequency frame FRM1_H may be equal to the input grayscale IG. The reference grayscale RG may mean a threshold grayscale at which a luminance drop that occurs when the refresh rate changes from the low frequency FRQ_L to the high frequency FRQ_H is perceived by the user. When the input grayscale IG is less than or equal to the reference grayscale RG, the luminance drop may be perceived by the user because a luminance of an image is relatively low. When the input grayscale IG is greater than the reference grayscale RG, the luminance drop might not be perceived by the user because the luminance of the image is relatively high.

In several embodiments, when the refresh rate changes from the low frequency FRQ_L to the high frequency FRQ_H, the frequency difference FRD between the high frequency FRQ_H and the low frequency FRQ_L is greater than or equal to the reference frequency difference value FRD_R, and the input grayscale IG is less than or equal to the reference grayscale RG, the output grayscale OG higher than the input grayscale IG may be sent to the pixel PX through the data driver 140. For example, when the refresh rate changes from the low frequency FRQ_L to the high frequency FRQ_H, the frequency difference FRD between the high frequency FRQ_H and the low frequency FRQ_L is greater than or equal to the reference frequency difference value FRD_R, and the input grayscale IG is less than or equal to the reference grayscale RG, the output grayscale OG of the first high-frequency frame FRM1_H may be increased to be higher than the input grayscale IG. For example, even if the refresh rate changes from the low frequency FRQ_L to the high frequency FRQ_H, when the frequency difference FRD between the high frequency FRQ_H and the low frequency FRQ_L is less than the reference frequency difference value FRD_R or the input grayscale IG is greater than the reference grayscale RG, the output grayscale OG of the first high-frequency frame FRM1_H may be equal to the input grayscale IG.

In several embodiments, when the output grayscale OG of the first high-frequency frame FRM1_H is increased to be higher than the input grayscale IG, the output grayscale OG of the second high-frequency frame FRM2_H may be equal to the input grayscale IG. For example, when grayscale compensation is performed for the first high-frequency frame FRM1_H, grayscale compensation for the second high-frequency frame FRM2_H might not be performed.

In several embodiments, as the frequency difference FRD between the high frequency FRQ_H and the low frequency FRQ_L increases, a compensation grayscale of the first high-frequency frame FRM1_H, which is a difference between the output grayscale OG of the first high-frequency frame FRM1_H and the input grayscale IG, may increase. As the frequency difference FRD between the high frequency FRQ_H and the low frequency FRQ_L increases, the luminance drop of the first high-frequency frame FRM1_H may increase. In several embodiments, the increased luminance drop of the first high-frequency frame FRM1_H may be compensated for by increasing the compensation grayscale of the first high-frequency frame FRM1_H. For example, as the compensation grayscale of the first high-frequency frame FRM1_H increases, the luminance drop which may be caused by the change of the display device's refresh rate may be reduced. Thus, a viewer might not perceive a decrease in luminance or flicker when the display device's refresh rate changes.

As illustrated in FIG. 5, when the display device's refresh rate changes from the low frequency FRQ_L to the high frequency FRQ_H, the frequency difference FRD between the high frequency FRQ_H and the low frequency FRQ_L is greater than or equal to the reference frequency difference value FRD_R, and the input grayscale IG is less than or equal to the reference grayscale RG, the grayscale compensation for the first high-frequency frame FRM1_H may be performed. When the input grayscales IG of the frames FRM_L, FRM1_H, FRM2_H, and FRM3_H are the same, the output grayscale OG of each of the low-frequency frame FRM_L, the second high-frequency frame FRM2_H, and the third high-frequency frame FRM3_H may be equal to the input grayscale IG, and the output grayscale OG of the first high-frequency frame FRM1_H may be increased to be higher than the input grayscale IG. For example, when the input grayscale IG is 64 G, the output grayscale OG of each of the low-frequency frame FRM_L, the second high-frequency frame FRM2_H, and the third high-frequency frame FRM3_H may be 64 G, and the output grayscale OG of the first high-frequency frame FRM1_H may be increased to 66 G. For example, the compensation grayscale of the first high-frequency frame FRM1_H may be 2 G.

As illustrated in FIG. 6, even if the refresh rate changes from the low frequency FRQ_L to the high frequency FRQ_H, when the frequency difference FRD between the high frequency FRQ_H and the low frequency FRQ_L is less than the reference frequency difference value FRD_R or the input grayscale IG is greater than the reference grayscale RG, the grayscale compensation for the first high-frequency frame FRM1_H might not be performed. When the input grayscales IG of the frames FRM_L, FRM1_H, FRM2_H, and FRM3_H are the same, the output grayscale OG of each of the low-frequency frame FRM_L, the first high-frequency frame FRM1_H, the second high-frequency frame FRM2_H, and the third high-frequency frame FRM3_H may be equal to the input grayscales IG. For example, when the input grayscale IG is 64 G, the output grayscale OG of each of the low-frequency frame FRM_L, the first high-frequency frame FRM1_H, the second high-frequency frame FRM2_H, and the third high-frequency frame FRM3_H may be 64 G.

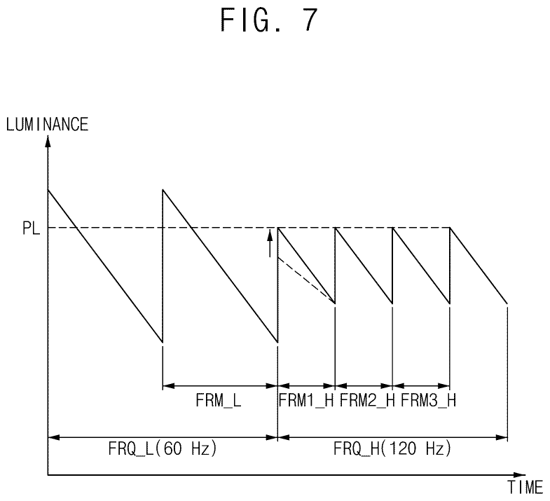

FIG. 7 is a graph illustrating a luminance of the display panel 110 of FIG. 1 when the display device's refresh rate changes from the low frequency FRQ_L to the high frequency FRQ_H, and when the grayscale compensation for the first high-frequency frame FRM1_H is performed.

Referring to FIG. 7, when the refresh rate changes from the low frequency FRQ_L to the high frequency FRQ_H, even if the hysteresis characteristic of the driving transistor T1 changes in the first high-frequency frame FRM1_H, the grayscale compensation for the first high-frequency frame FRM1_H may be performed (in other words, the output grayscale OG of the first high-frequency frame FRM1_H may be increased to be higher than the input grayscale IG), and accordingly, the peak luminance PL of the first high-frequency frame FRM1_H may be substantially equal to the peak luminance PL of the other high-frequency frames FRM2_H and FRM3_H. For example, when the refresh rate changes from the low frequency FRQ_L to the high frequency FRQ_H, the luminance drop in the first high-frequency frame FRM1_H may be reduced or substantially prevented. Since the luminance drop which may be caused by the first high-frequency frame FRM1_H is reduced, a viewer might not perceive a flicker when the display device's refresh rate changes from the low frequency FRQ_L to the high frequency FRQ_H.

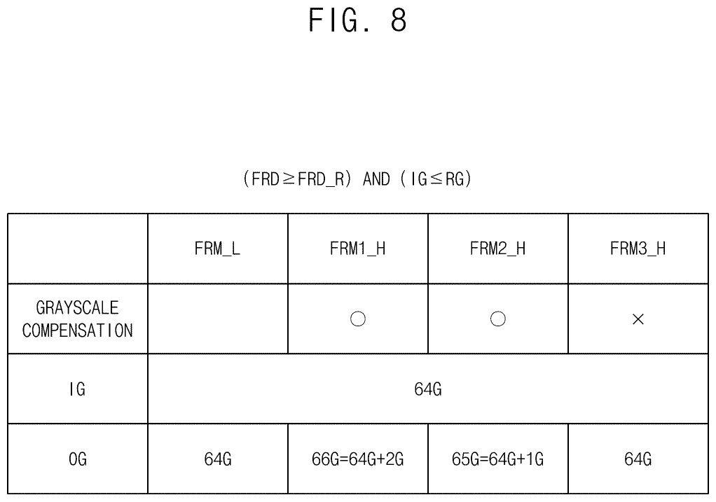

FIG. 8 is a table illustrating the output grayscales OG of the frames FRM_L, FRM1_H, FRM2_H, and FRM3_H when the refresh rate changes from the low frequency FRQ_L to the high frequency FRQ_H according to an embodiment.

Referring to FIG. 8, in several embodiments, when the output grayscale OG of the first high-frequency frame FRM1_H is higher than the input grayscale IG, the output grayscale OG of the second high-frequency frame FRM2_H may be higher than the input grayscale IG. For example, when the grayscale compensation for the first high-frequency frame FRM1_H is performed, the grayscale compensation for the second high-frequency frame FRM2_H may also be performed. In an embodiment, when the output grayscale OG of the first high-frequency frame FRM1_H is increased to be higher than the input grayscale IG, the output grayscale OG of the second high-frequency frame FRM2_H may be increased to be higher than the input grayscale IG and less than the output grayscale OG of the first high-frequency frame FRM1_H.

When the refresh rate changes from the low frequency FRQ_L to the high frequency FRQ_H, the frequency difference FRD between the high frequency FRQ_H and the low frequency FRQ_L is greater than or equal to the reference frequency difference value FRD_R, and the input grayscale IG is less than or equal to the reference grayscale RG, the grayscale compensation for the first high-frequency frame FRM1_H and the second high-frequency frame FRM2_H may be performed. When the input grayscales IG of the frames FRM_L, FRM1_H, FRM2_H, and FRM3_H are the same, the output grayscale OG of each of the low-frequency frame FRM_L and the third high-frequency frame FRM3_H may be equal to the input grayscales IG, the output grayscale OG of the first high-frequency frame FRM1_H may be higher than the input grayscale IG, and the output grayscale OG of the second high-frequency frame FRM2_H may be higher than the input grayscale IG and less than the output grayscale OG of the first high-frequency frame FRM1_H. For example, when the input grayscale IG is 64 G, the output grayscale OG of each of the low-frequency frame FRM_L and the third high-frequency frame FRM3_H may be 64 G, the output grayscale OG of the first high-frequency frame FRM1_H may be 66 G, and the output grayscale OG of the second high-frequency frame FRM2_H may be 65 G. For example, the compensation grayscale of the first high-frequency frame FRM1_H may be 2 G, and the compensation grayscale of the second high-frequency frame FRM2_H may be 1 G.

In several embodiments, when the display device's refresh rate changes from the low frequency FRQ_L to the high frequency FRQ_H, the output grayscales OG for the first high-frequency frame FRM1_H and the second high-frequency frame FRM2_H may be compensated for. For example, an output grayscale OG of the second high-frequency frame FRM2_H may be increased to be higher than the input grayscale IG. Additionally, an output grayscale OG of the first high-frequency frame FRM1_H may be increased to be higher than the output grayscale OG of the second high-frequency frame FRM2_H. The output grayscales OG for the first high-frequency frame FRM1_H and the second high-frequency frame FRM2_H may be sent to the Pixel PX through the data driver 140. In several embodiments, increasing the output grayscales OG for the first high-frequency frame FRM1_H and the second high-frequency frame FRM2_H ensures that the viewer's perception of a decreased luminance is reduced.

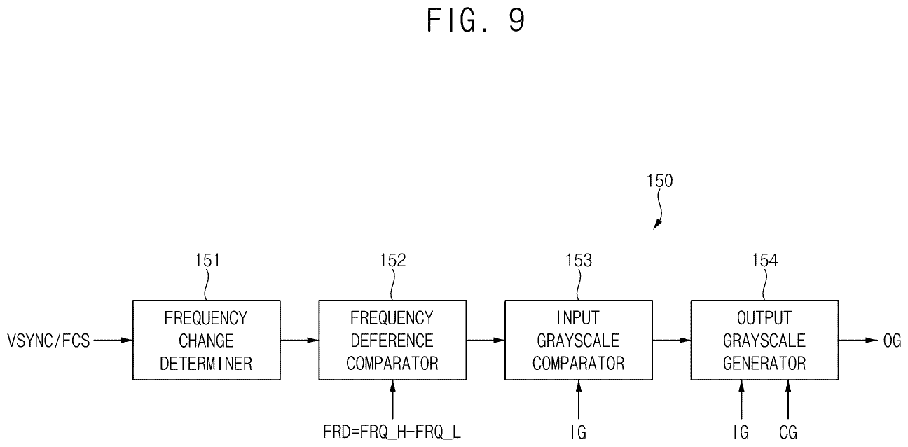

FIG. 9 is a block diagram illustrating an example of the controller 150 of FIG. 1.

Referring to FIGS. 1 and 9, the controller 150 may include a frequency change determiner 151, a frequency difference comparator 152, an input grayscale comparator 153, and an output grayscale generator 154.

The frequency change determiner 151 may determine whether the refresh rate has changed based on a vertical synchronization signal VSYNC or a frequency change signal FCS. The control signal CTRL may include the vertical synchronization signal VSYNC and/or the frequency change signal FCS. When the refresh rate changes, a cycle of pulses of the vertical synchronization signal VSYNC may change, and accordingly, the frequency change determiner 151 may determine whether the refresh rate has changed based on the vertical synchronization signal VSYNC. When the refresh rate changes, the frequency change signal FCS may include a pulse, and accordingly, the frequency change determiner 151 may determine whether the refresh rate has changed based on the frequency change signal FCS.

The frequency difference comparator 152 may compare the frequency difference FRD between the high frequency FRQ_H and the low frequency FRQ_L with the reference frequency difference value FRD_R. In several embodiments, the frequency difference FRD may correspond to a value FRQ_H-FRQ_L obtained by subtracting the low frequency FRQ_L from the high frequency FRQ_H.

The input grayscale comparator 153 may compare the input grayscale IG with the reference grayscale RG.

The output grayscale generator 154 may generate the output grayscale OG based on the input grayscale IG. In several embodiments, the output grayscale OG may be generated based on the input grayscale IG and the display device's refresh rate. When performing grayscale compensation for a frame, the output grayscale generator 154 may generate the output grayscale OG as a value obtained by adding the compensation grayscale CG to the input grayscale IG. When not performing the grayscale compensation for the frame, the output grayscale generator 154 may generate the output grayscale OG equal to the input grayscale IG.

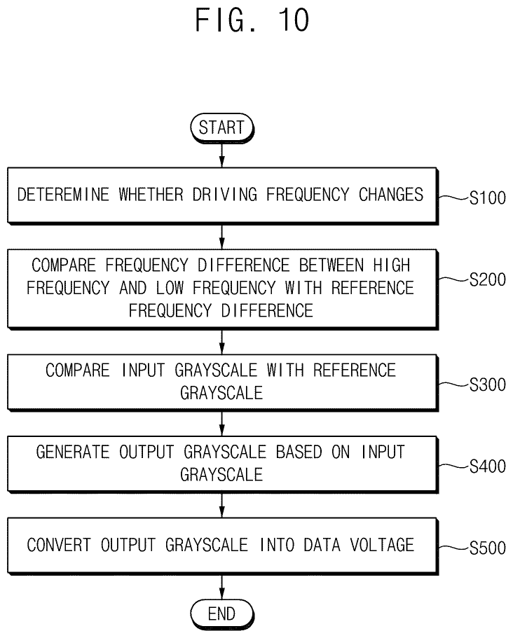

FIG. 10 is a flowchart illustrating a method of driving a display device 100 according to an embodiment.

Referring to FIGS. 1, 5, 6, and 8 to 10, in the method of driving the display device 100, the frequency change determiner 151 may determine whether the refresh rate has changed in step S100. In several embodiments, the frequency change determiner 151 may determine whether the refresh rate has changed based on the vertical synchronization signal VSYNC or the frequency change signal FCS.

In step S200, the frequency difference comparator 152 may compare the frequency difference FRD between the high frequency FRQ_H and the low frequency FRQ_L with the reference frequency difference value FRD_R.

In step S300, the input grayscale comparator 153 may compare the input grayscale IG with the reference grayscale RG.

In step S400, the output grayscale generator 154 may generate the output grayscale OG based on the input grayscale IG. When performing grayscale compensation for a frame, the output grayscale generator 154 may generate the output grayscale OG as a value obtained by adding the compensation grayscale CG to the input grayscale IG. When grayscale compensation is not performed for a frame, the output grayscale generator 154 may generate the output grayscale OG equal to the input grayscale IG.

In step S500, the data driver 140 may convert the output grayscale OG into data voltage VDAT.

In several embodiments, when the display device's refresh rate changes from the low frequency FRQ_L to the high frequency FRQ_H, the output grayscale OG of the first high-frequency frame FRM1_H may be increased to be higher than the input grayscale IG. Thus, the viewer's perception of a decreased luminance may be reduced.

In several embodiments, when the display device's refresh rate changes from the low frequency FRQ_L to the high frequency FRQ_H, the frequency difference FRD between the high frequency FRQ_H and the low frequency FRQ_L is greater than or equal to the reference frequency difference value FRD_R, and the input grayscale IG is less than or equal to the reference grayscale RG, the output grayscale OG of the first high-frequency frame FRM1_H may be increased to be higher than the input grayscale IG. Even if the refresh rate changes from the low frequency FRQ_L to the high frequency FRQ_H, when the frequency difference FRD between the high frequency FRQ_H and the low frequency FRQ_L is less than the reference frequency difference value FRD_R or the input grayscale IG is greater than the reference grayscale RG, the output grayscale OG of the first high-frequency frame FRM1_H may be equal to the input grayscale IG.

In several embodiments, when the output grayscale OG of the first high-frequency frame FRM1_H is increased to be higher than the input grayscale IG, the output grayscale OG of the second high-frequency frame FRM2_H may be equal to the input grayscale IG. For example, when grayscale compensation is performed for the first high-frequency frame FRM1_H, grayscale compensation for the second high-frequency frame FRM2_H might not be performed.

In several embodiments, when the output grayscale OG of the first high-frequency frame FRM1_H is increased to be higher than the input grayscale IG, the output grayscale OG of the second high-frequency frame FRM2_H may be increased to be higher than the input grayscale IG. For example, when the grayscale compensation is performed for the first high-frequency frame FRM1_H, the grayscale compensation for the second high-frequency frame FRM2_H may be performed. In an embodiment, when the output grayscale OG of the first high-frequency frame FRM1_H is increased to be higher than the input grayscale IG, the output grayscale OG of the second high-frequency frame FRM2_H may be increased to be higher than the input grayscale IG and less than the output grayscale OG of the first high-frequency frame FRM1_H.

In an embodiment, as the frequency difference FRD between the high frequency FRQ_H and the low frequency FRQ_L increases, the compensation grayscale CG of the first high-frequency frame FRM1_H, which is the difference between the output grayscale OG of the first high-frequency frame FRM1_H and the input grayscale IG, may increase.

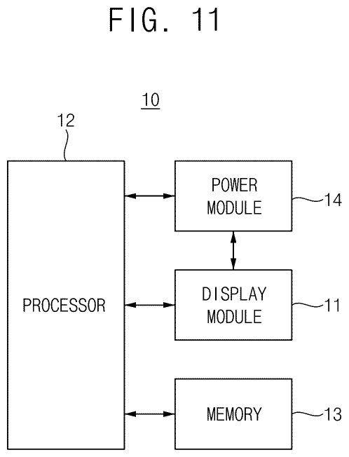

FIG. 11 is a block diagram illustrating an electronic device 10 according to an embodiment.

Referring to FIG. 11, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller. The processor may provide the input image data IMD1 of FIG. 1 to the display module 11.

The memory 13 may store data information necessary for an operation of the processor 12 or the display module 11. When the processor 12 executes an application stored in the memory 13, the input image data IMD1 and the control signal CTRL of FIG. 1 may be transmitted to the display module 11, and the display module 11 may output image information based on the input image data IMD1 and the control signal CTRL.

The power module 14 may include a power supply module such as a power adapter, a battery device, etc. and a power conversion module that converts power supplied by the power supply module to generate power required for an operation of the electronic device 10.

At least one of the components of the electronic device 10 described above may be included in the display device 100 of FIG. 1, according to several embodiments described above. Further, some of individual modules functionally included in one module may be included in the display device 100, and others may be provided separately from the display device 100. For example, the display device 100 may include the display module 11, and the processor 12, the memory 13, and the power module 14 may be provided in the form of other devices within the electronic device 11 other than the display device 100.

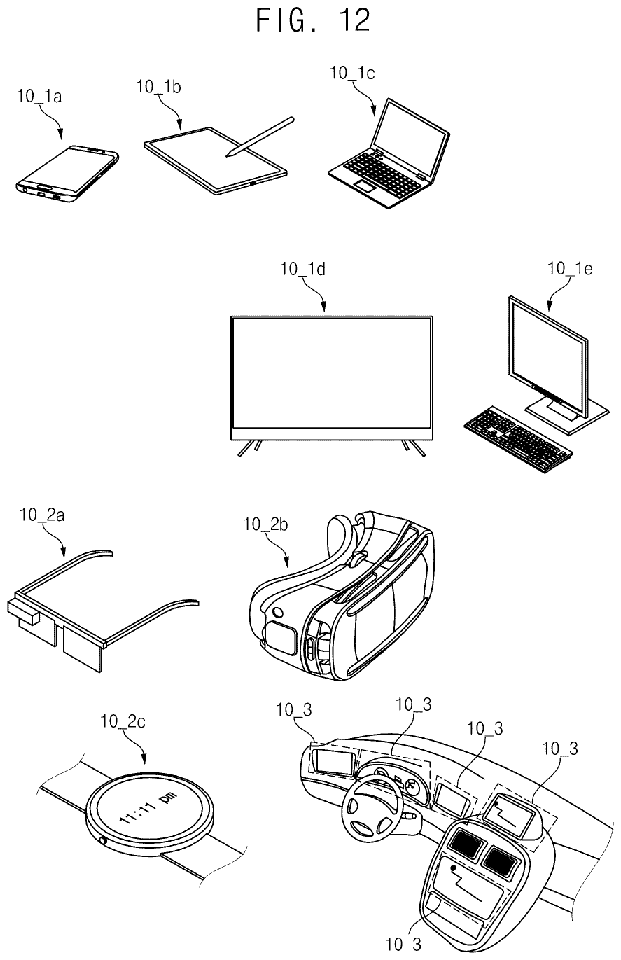

FIG. 12 is a diagram illustrating examples of electronic devices according to several embodiments.

Referring to FIG. 12, electronic devices to which display device of the present disclosure may be applied include not only image display electronic devices such as a smart phone 10_1a, a tablet computer 10_1b, a laptop computer 10_1c, a TV 10_1d, a computer monitor 10_1e, etc., but also wearable electronic devices including display modules such as smart glasses 10_2a, a head mounted display 10_2b, a smart watch 10_2c, and vehicle electronic devices 10_3 including display modules such as an instrument panel of an automobile, a center fascia, a center information display CID arranged on a dashboard, a room mirror display, etc.

In several embodiments, the display device of the present disclosure may be included in a computer, a notebook computer, a mobile phone, a smart phone, a smart pad, a smart watch, a portable media player PMP, a personal digital assistant PDA, an MP3 player, or the like.

Although the display device, the method of driving the display device, and the electronic device according to several embodiments of the present disclosure have been described with reference to the drawings. Those skilled in the art will recognize that the present disclosure can be practiced in other specific ways without departing from its technical spirit or essential characteristics. The described embodiments should be regarded as illustrative rather than being restrictive in all aspects. Although embodiments of the present disclosure have been described with reference to the accompanying drawings, the disclosure is not necessarily limited to these embodiments and may be implemented in various forms.

What is claimed is:

1. A display device, comprising:
a display panel including a pixel; and
a controller configured to receive input grayscale and refresh rate data and generate output grayscales based on an input grayscale and a refresh rate, and transmit the output grayscales to a data driver,
wherein, when the refresh rate changes from a low frequency to a higher frequency, an output grayscale higher than the input grayscale is sent to the pixel through the data driver.

2. The display device of claim 1, wherein, when the refresh rate changes from the low frequency to the higher frequency and a frequency difference between the higher frequency and the low frequency is greater than or equal to a reference frequency difference value, the output grayscale higher than the input grayscale is sent to the pixel through the data driver.

3. The display device of claim 1, wherein, when the refresh rate changes from the low frequency to the higher frequency and the input grayscale is less than or equal to a reference grayscale, the output grayscale higher than the input grayscale is sent to the pixel through the data driver.

4. The display device of claim 1, wherein, when the refresh rate changes from the low frequency to the higher frequency, a frequency difference between the higher frequency and the low frequency is greater than or equal to a reference frequency difference value, and the input grayscale is less than or equal to a reference grayscale, the output grayscale higher than the input grayscale is sent to the pixel through the data driver.

5. The display device of claim 1, wherein:
high-frequency frames include a first high-frequency frame and a second high-frequency frame,
an output grayscale of the first high-frequency frame that is higher than the input grayscale is sent to the pixel, and
an output grayscale of the second high-frequency frame that is equal to the input grayscale is sent to the pixel.

6. The display device of claim 1, wherein:
high-frequency frames include a first high-frequency frame and a second high-frequency frame, and
an output grayscale of the second high-frequency frame that is higher than the input grayscale is sent to the pixel.

7. The display device of claim 5, wherein the output grayscale of the second high-frequency frame is less than the output grayscale of the first high-frequency frame.

8. The display device of claim 5, wherein a compensation grayscale of the first high-frequency frame corresponding to a difference between the output grayscale of the first high-frequency frame and the input grayscale, increases as a frequency difference between the higher frequency and the low frequency increases.

9. The display device of claim 1, wherein the controller includes:
a frequency change determiner configured to determine a change in the refresh rate based on a vertical synchronization signal or a frequency change signal;
a frequency difference comparator configured to compare a frequency difference between the higher frequency and the low frequency with a reference frequency difference value; and
an input grayscale comparator configured to compare the input grayscale with a reference grayscale.

10. A method of driving a display device, the method comprising:
receiving input grayscale and refresh rate data;
generating output grayscales based on an input grayscale and a refresh rate; and
transmitting the output grayscales to a data driver;
wherein, when the refresh rate of the display device changes from a low frequency to a higher frequency, an output grayscale higher than the input grayscale is sent to a pixel through the data driver.

11. The method of claim 10, further comprising:
determining a change in the refresh rate based on a vertical synchronization signal or a frequency change signal.

12. The method of claim 10, further comprising:
comparing a frequency difference between the higher frequency and the low frequency with a reference frequency difference value; and
comparing the input grayscale with a reference grayscale.

13. The method of claim 12, wherein, when the refresh rate changes from the low frequency to the higher frequency, the frequency difference is greater than or equal to the reference frequency difference value, and the input grayscale is less than or equal to the reference grayscale, the output grayscale higher than the input grayscale is sent to the pixel through the data driver.

14. The method of claim 10, wherein:
high-frequency frames include a first high-frequency frame and a second high-frequency frame, and
an output grayscale of the second high-frequency frame that is equal to the input grayscale is sent to the pixel.

15. The method of claim 10, wherein:
high-frequency frames include a first high-frequency frame and a second high-frequency frame, and
an output grayscale of the second high-frequency frame that is higher than the input grayscale is sent to the pixel.

16. The method of claim 15, wherein the output grayscale of the second high-frequency frame that is less than an output grayscale of the first high-frequency frame is sent to the pixel.

17. The method of claim 16, wherein a compensation grayscale of the first high-frequency frame corresponding to a difference between the output grayscale of the first high-frequency frame and the input grayscale, increases as a frequency difference between the higher frequency and the low frequency increases.

18. An electronic device, comprising:
a display device configured to display an image;
a processor configured to provide an input grayscale to the display device; and
a power module configured to supply power to the display device and the processor,
wherein the display device comprises:
a display panel including a pixel; and
a controller configured to receive input grayscale and refresh rate data and generate output grayscales based on an input grayscale and a refresh rate, and transmit the output grayscales to a data driver, wherein, when the refresh rate of the display panel changes from a low frequency to a higher frequency, an output grayscale higher than the input grayscale is sent to the pixel through the data driver.

19. The electronic device of claim 18, wherein, when the refresh rate changes from the low frequency to the higher frequency and a frequency difference between the higher frequency and the low frequency is greater than or equal to a reference frequency difference value, the output grayscale higher than the input grayscale is sent to the pixel through the data driver.

20. The electronic device of claim 18, wherein, when the refresh rate changes from the low frequency to the higher frequency and the input grayscale is less than or equal to a reference grayscale, the output grayscale higher than the input grayscale is sent to the pixel through the data driver.
